(19) United States
(12) Patent Application Publication
(10) Pub. No.: US 2024/0303572 A1
(43) Pub. Date: Sep. 12, 2024

(54) IDENTIFICATION OF SIMILAR PROCESSES IN ENTERPRISE

(71) Applicant: Wells Fargo Bank, N.A., San Francisco, CA (US)

(72) Inventors: Michael Bortis, Tustin, CA (US); Guangcao Ji, Plano, TX (US); Carlton Jay Lindgren, JR., Denver, CO (US); Manesh Saini, New York, NY (US); Winthrop Treynor Smith, Littleton, CO (US); Ronald Sobey, Porter, TX (US)

(21) Appl. No.: 18/181,848

(22) Filed: Mar. 10, 2023

(51) Int. Cl. G06Q 10/0635

(52) U.S. Cl. CPC G06Q 10/0635

(57) ABSTRACT

An example computer system for identifying similar processes can include: one or more processors; and non-transitory computer-readable storage media encoding instructions which, when executed by the one or more processors, causes the computer system to create: a similarity engine programmed to use machine learning to analyze a plurality of processes for an enterprise; a models engine programmed to identify similarities between the plurality of processes using the machine learning; and a display engine programmed to display the similarities between the plurality of processes.

### BACKGROUND

A large enterprise can have hundreds or thousands of different processes that are used to conduct business. Many of these processes can be similar in function but may be developed and deployed separately. It can therefore be difficult, particularly for large enterprises, to manage these process.

### SUMMARY

Examples provided herein are directed to identification of similar processes.

According to one aspect, an example computer system for identifying similar processes can include: one or more processors; and non-transitory computer-readable storage media encoding instructions which, when executed by the one or more processors, causes the computer system to create: a similarity engine programmed to use machine learning to analyze a plurality of processes for an enterprise; a models engine programmed to identify similarities between the plurality of processes using the machine learning; and a display engine programmed to display the similarities between the plurality of processes.

According to another aspect, an example method for identifying similar processes can include: using machine learning to analyze a plurality of processes for an enterprise; identifying similarities between the plurality of processes using the machine learning; and displaying the similarities between the plurality of processes.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for identifying similar processes.

FIG. 2 shows example logical components of a server device of the system of FIG. 1.

FIG. 3 shows an example matrix of the processes generated by the server device of FIG. 2.

FIG. 4 shows example physical components of the server device of FIG. 2.

### DETAILED DESCRIPTION

This disclosure relates to the identification of similar processes within an enterprise.

A large enterprise can have hundreds or thousands of different processes that are used to conduct business. Many of these processes can be similar in function. It is therefore desirable to consolidate those processes to realize efficiencies. However, due to the large number of processes, it can be time consuming to identify like processes for consolidation.

Managing the processes can therefore become difficult. This can result in a large number of processes that are identical or nearly identical in substance but implemented as separate processes, such as in different parts of the enterprise. Such redundancy can result in inefficiencies and additional overhead to manage the processes.

Examples in this disclosure involve the identification of these similar processes. Specifically, the disclosure provides techniques to identify processes that are the same, very similar, or close enough to be considered to be the same process. In such instances, the processes can be consolidated into one.

In some examples, the consolidation of the processes can involve using artificial intelligence (AI) to review all the processes and identify those which appear to be similar. AI techniques like Doc2Vec (an Natural Language Processing (NLP) tool for representing documents as a vector), Bidirectional Encoder Representations from Transformers (BERT—a transformer-based machine learning technique for NLP pre-training), and Text-to-Text Transfer Transformer (T5—a transformer-based architecture that uses a text-to-text approach), all of which are described further below, can be used to calculate a similarity score between each process based upon attributes of the process (e.g., summary, purpose, and scope metadata). The results can be filtered, and review can be focused only on those processes that have a similarity score above a threshold. This greatly reduces the number of possible similar processes that need to be reviewed.

There can be various advantages associated with the technologies described herein. For instance, there are processing inefficiencies associated with the management and implementation of redundant processes. By identifying similar processes to avoid redundancy, the systems of the enterprise can perform more efficiently. Further, risks of inconsistent and improper outcomes associated with similar processes are possible. For instance, when updating a process based upon changes in policy or functionality, it is possible that some similar processes fail to be identified and updated. This could result in inconsistent outcomes. Many other advantages can be associated with identifying the number of similar processes for an enterprise.

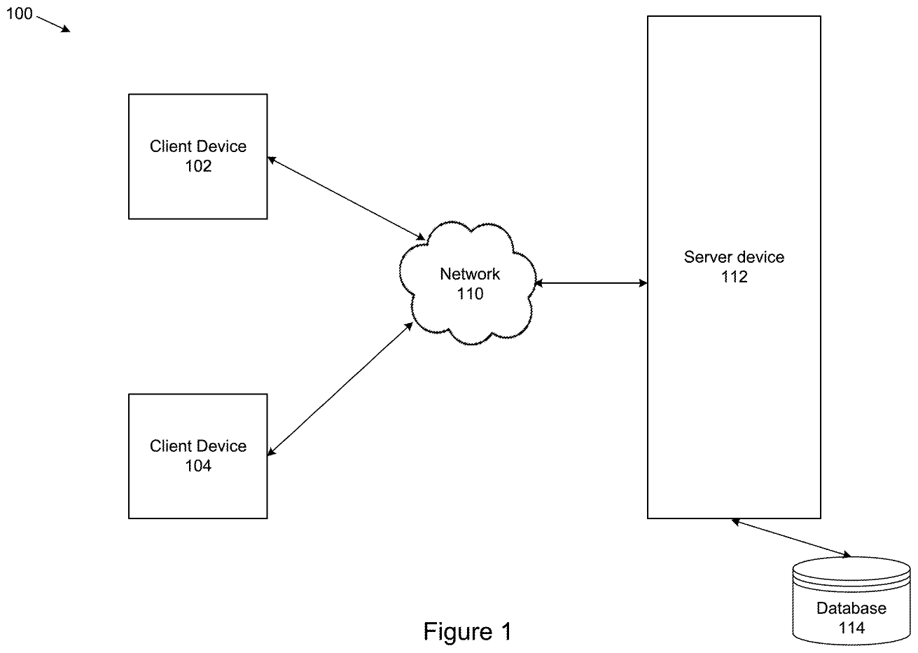

FIG. 1 schematically shows aspects of one example system 100 programmed to identify similar processes. In this example, the system 100 can be a computing environment that includes a plurality of client and server devices. In this instance, the system 100 includes client devices 102, 104, a server device 112, and a database 114. The client devices 102, 104 and the server device 112 can communicate through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

The example client devices 102 and 104 are programmed to communicate with the server device 112 to access business processes associated with the system 100. For instance, as described further below, the server device 112 can provide financial services. The client devices 102 and 104 can therefore access the server device 112 to request such financial services, such as gaining access to checking and savings accounts, making transfers and purchases, obtaining loans, etc.

In some non-limiting examples, the server device 112 is owned by a financial institution, such as a bank. The example server device 112 is programmed to provide financial services to the client devices 102, 104.

The example database 114 is programmed to store information about the processes of the system 100. As described further herein, this information can include metadata, such as textual descriptions of the processes. This metadata can also include other information associated with the processes, such as the business divisions or departments responsible for the processes, when the processes were first implemented, when the processes were most recently modified, geographic regions to which the processes apply, types of individuals impacted by the processes (e.g., banking customers, mortgage customers, investment customers, vendors, consultants, employees, independent contractors, etc.), a line of business to which the processes apply, a product to which the processes apply, a type of the process, and so forth. Many other configurations are possible.

The network 110 provides a wired and/or wireless connection between the client devices 102, 104 and the server device 112. In some examples, the network 110 can be a local area network, a wide area network, the Internet, or a mixture thereof. Many different communication protocols can be used. Although only three devices are shown, the system 100 can accommodate hundreds or thousands of computing devices.

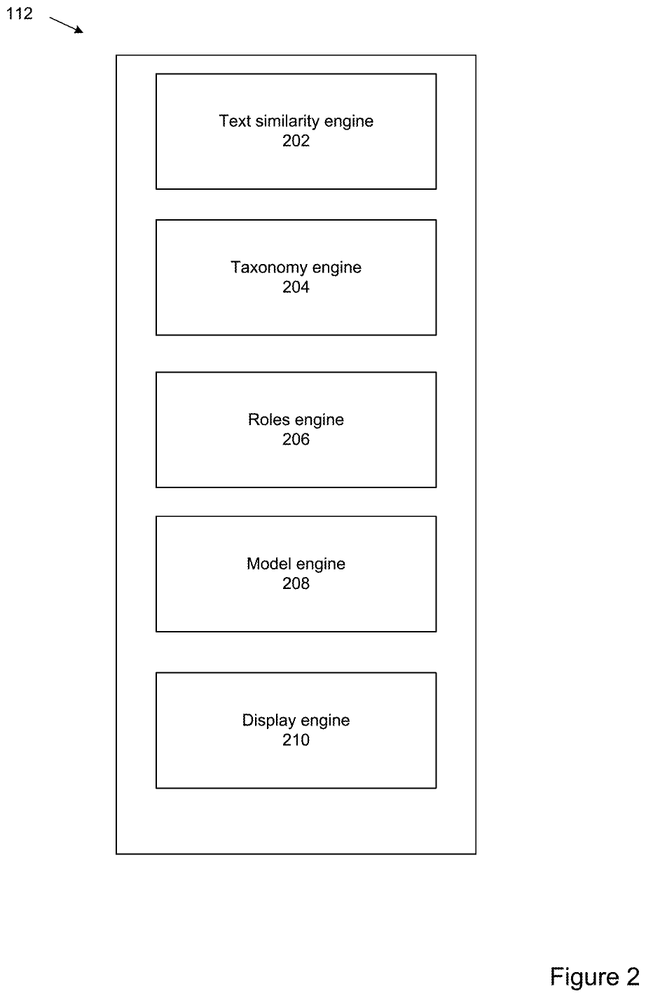

Referring now to FIG. 2, additional details of the server device 112 are shown. In this example, the server device 112 has various logical modules that can be programmed to identify similar processes used by the system 100.

Generally, the server device 112 can be programmed to find similar processes. Further, the server device 112 can be programmed to identify and recommend processes that best address a particular need. Finally, the server device 112 can provide feedback on processes being entered into the database 114. More or less functionality can be provided, as described herein.

In the examples provided herein, a process can be a logical group of steps, performed with or without software, which provide functionality for a particular purpose for an enterprise. In some examples, a process can include one or more applications that are executed on a computing device.

For instance, one example process is a credit analysis that is used to determine whether a customer qualifies for a loan. The process can include obtaining the customer's bibliographic information, obtaining credit information from a reporting agency, and comparing the results. This process can include a series of steps and utilize one or more applications to accomplish the process.

Another example process is a determination that a customer has submitted sufficient financial information to validate a credit analysis. The process may include a determination of the necessary information from the customer, a determination of what, if any, documentation that is missing, and a comparison to control and/or risk information to determine compliance.

As described, an enterprise can have hundreds or thousands of processes that are used to provide the functionality necessary to allow the enterprise to service its customers.

The server device 112 can, in this instance shown in FIG. 2, include a text similarity engine 202, a taxonomy engine 204, a roles engine 206, a model engine 208, and a display engine 210. In other examples, more or fewer engines providing different functionality can be used.

The example text similarity engine 202 is programmed to assemble aspects associated with each of the processes to determine a similarity between the processes. In this example, the text similarity engine 202 can be programmed to assemble various metadata associated with each of the processes, such as: (i) process name providing a name of the process; (ii) process summary providing a summary of a function of the process; (iii) process scope providing a scope for the process; (iv) process purpose providing a purpose for the process; (v) controls description providing a summary of the controls associated with the process; and/or (vi) a risk description providing a summary of the risks associated with the process.

The example taxonomy engine 204 is programmed to compare taxonomies between processes found to be similar by the text similarity engine 202. For instance, the taxonomy engine 204 can be programmed to arrange a hierarchy of processes based upon different attributes associated with the enterprise, such as by line of business, sub-business unit, detail business unit, etc.

The example roles engine 206 is programmed to compare roles between processes found to be similar by the text similarity engine 202. For instance, the roles engine 206 can be programmed to arrange processes based upon different roles within the enterprise, such as treasury consultant, human resource data administrator, loan review manager, etc.

The example model engine 208 is programmed to use the information from the text similarity engine 202, the taxonomy engine 204, and the roles engine 206 to model a possible similarity between processes. In one example, the model engine 208 creates a ranked ordered list of processes with may be similar and possibly consolidated.

In one example, the model engine 208 is programmed to apply advanced analytics to create the ordered list. In this example, the model engine 208 creates a long string of the activity names within a process and identifies similar strings/combinations of words between the activities of multiple processes. The higher the number of similar word combinations across multiple activities between two processes, the higher the similarity score given to the two processes.

In addition to evaluating process name similarity, the model engine 208 can be programmed to analyze a string of the summary, purpose, and/or scope for each of the processes and identify similar strings/combinations of words across the three attributes.

For instance, the following examples summaries for two processes are analyzed by the model engine 208. Similarities are noted by the model engine 208 (see underlined words).
Summary A: Provides a standard and consistent method for Digital Platforms to process Digital Small Business Deposit Product applications. This process includes determining whether the customer is new or existing, obtaining and verifying business customer information, and displaying account consent and disclaimers.
Summary B: Provides a standard and consistent method for Digital Platforms to process Digital Consumer Credit Card applications. This process includes determining whether the customer is new or existing, obtaining applicant information, provide promotional balance transfer offers, and displaying account consent and disclaimers.

Various mechanisms can be used by the model engine 208 to determine similarities between processes. Examples of these mechanisms include AI, as described above.

For instance, the model engine 208 can use Doc2Vec to determine similarities between processes. In such an example, the metadata associated with the processes is cleaned, such as by removing hypertext markup language tags, special characters, and/or stop words. Further, the model engine 208 can be programmed to lemmatize words and create a corpus of combined summary, purpose, process, and scope for each of the processes.

The model engine 208 can then be programmed to build a vocabulary based upon the corpus. This can include: (i) train the model; obtain a normalized vector for each document; (iii) calculate a similarity score for each process pair; and (iv) identify process pairs that exceed an appropriate threshold. In some examples, the threshold can be created automatically and/or from input from subject matter experts who review the pairs. Different models can use different thresholds, as appropriate.

In another example, the model engine 208 can use BERT to determine similarities between processes. In this example, the metadata associated with the processes can be used without significant cleaning. The model engine 208 can create a corpus of information, including a combined summary, purpose, process, and scope for each of the processes. The model engine 208 is then programmed to: (i) encode corpus based on the BERT model; (ii) calculate a similarity score for each process pair (e.g., using util.pytorch_cos_sim, a PyTorch script for determining similarity); and (iii) identify process pairs that exceed appropriate threshold. Again, the threshold can be created automatically and/or from input from subject matter experts who review the pairs.

In another example, the model engine 208 can use ST5 to determine similarities between processes. In this example, the metadata associated with the processes can be used without significant cleaning. The model engine 208 can again create a corpus of information, including a combined summary, purpose, process, and scope for each of the processes. The model engine 208 is then programmed to: (i) encode corpus based on the ST5 model; (ii) calculate the similarity score for each process pair (e.g., using util.pytorch_cos_sim, a PyTorch script for determining similarity); and (iii) identify process pairs that exceed appropriate threshold. Again, the threshold can be created automatically and/or from input from subject matter experts who review the pairs.

In one embodiment, the model engine 208 uses the ST5 model to determine similarities between the processes. In such an embodiment, the threshold is set at 0.9. Any process pairs having a similarity score that meets or exceeds the threshold of 0.9 are identified as being similar for further review.

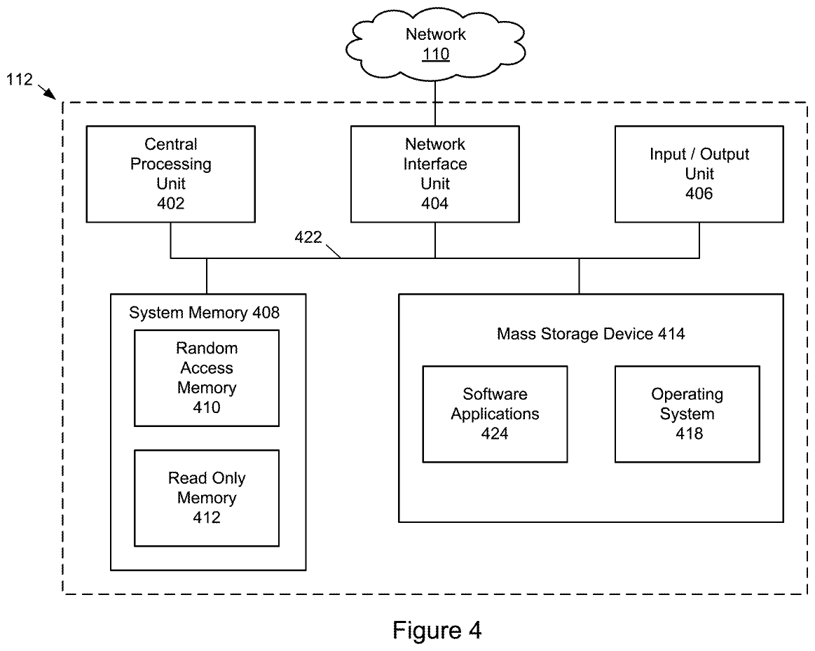

The example display engine 210 is programmed to display the output of the model engine 208. A graphical user interface depicting the output of the display engine 210 is provided in FIG. 4, described below.

In one example, the display engine 210 is programmed to provide multiple outputs. These outputs can include one or more ordered lists of possibly similar processes and/or detailed information on the possibly similar processes.

One example output of the display engine 210 is provided in the table below. In this example, a list of the process pairs is provided that exceed the threshold and are likely to be similar processes. Each process pair is identified by identification numbers. Further, a number of possibly similar processes is provided. Finally, an indication of the likelihood that the processes are similar can be provided based upon the similarity score. For instance, processes having a similarity score above the threshold are indicated as having a “Medium” likelihood of being similar, while processes having a similarity score that exceeds the threshold by a certain amount are indicated as having progressively “High” and “Very High” likelihoods of similarity.

| | Similar | # of Similar | Similarity |
|---|---|---|---|
| Process ID | Process ID | Processes | Group |
| Process 1 | Process 23 | 3 | Very High |
| Process 1 | Process 45 | 3 | High |
| Process 1 | Process 12 | 3 | Medium |

In other examples, the display engine 210 outputs an interface that shows additional details about each pair of processes that may be similar. This can include such information as taxonomy, group, line of business, product, application, roles, summary, scope, purpose, name, similarity score, controls, and/or risks.

For instance, in the table that follows, the display engine 210 provides details on a pair of processes that may be similar. In this example, the table includes a sample similarity score, process identifier, name, summary, purpose, and scope.

| Similarity | Process | | | | |
|---|---|---|---|---|---|
| Score | ID | Name | Summary | Purpose | Scope |
| 1 | ID1 | Risk | Provides a consistent | The purpose is to | This process starts |
| | | Management | method for the team to | ensure accurate | when data is |
| | | Reporting | produce, review and | and timely data is | available. The |
| | | | report risk | available to | expected input is |
| | | | management. This | publish and | market risk data. The |
| | | | process includes | distribute risk | expected outputs of |
| | | | sourcing data, | reporting. The | this process are |
| | | | reviewing content, and | outcome of the | complete and accurate |
| | | | producing report, and | process is | data. |
| | | | distributing report to | accurate data for | |
| | | | stakeholders. | use in reporting. | |
| 95.0% | ID2 | Market Risk | Provides a consistent | The purpose is to | This process starts |
| | | Reporting | method for reporting | ensure reports are | when data is |
| | | | risk. This process | complete and | available. This |
| | | | includes sourcing data | accurate. The | process ends when |
| | | | and distributing report | expected | reports are distributed. |
| | | | to stakeholders. | outcome is | The expected inputs |
| | | | | accurate risk | to this process are |
| | | | | reporting. | listed as follows: risk |
| | | | | | data. The expected |
| | | | | | outputs of this process |
| | | | | | are listed as follows: |
| | | | | | risk reports. |

In this example, the process 644633 has a similarity score of 95 as compared with the process 646362. The information provided in the table can be used to decide whether the two processes are sufficiently similar. If so, the processes can be consolidated and/or one of the processes eliminated. Many other configurations are possible.

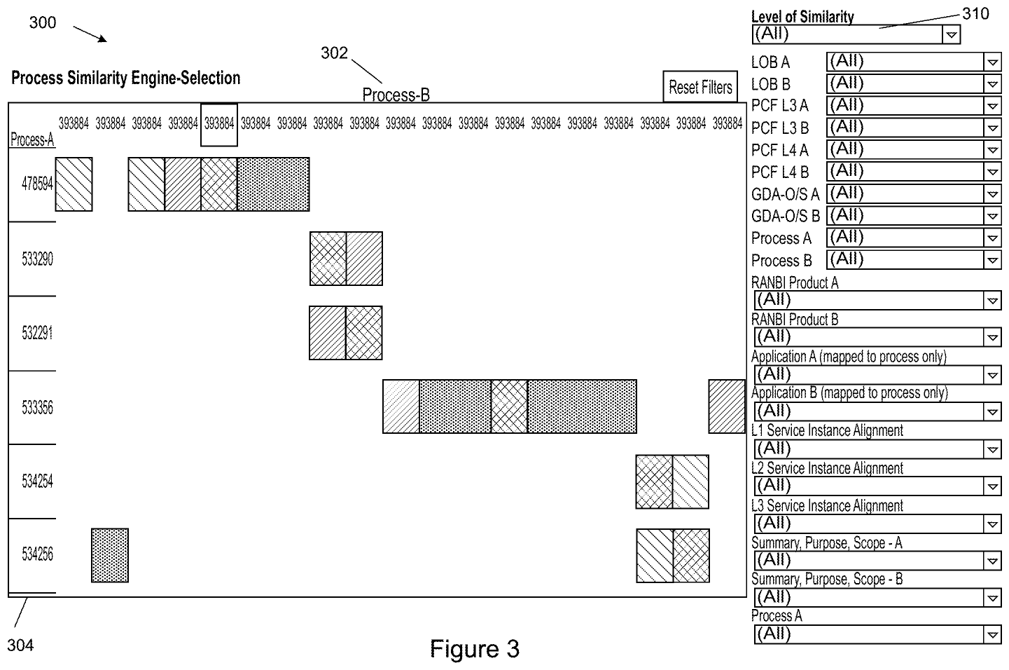

FIG. 3 illustrates an example interface 300 that is generated by the display engine 210 of the server device 112. In this example, the interface 300 creates a matrix that visually shows clusters of processes that can be assessed for possible consolidation.

In this example, the interface 300 lists processes 302 and 304 along the vertical and horizontal accesses. An indicator, such as color, is then used to identify the clusters of similar processes. For instance, a high concentration of processes with similarity 0.50-0.70 (Red), 0.70-0.85 (Yellow), and >0.85 (Green) shows a cluster of processes having significant similarity in either name, summary, purpose, or scope. These clusters can then be used for identification of candidates for consolidation.

In addition, the interface 300 includes a filter control 310 that allows the user to define what processes are shown on the matrix in the interface 300. For instance, the filter control 310 allows the user to filter by such parameters as: (i) level of similarity defining a specific amount of similarity between processes, such as a similarity greater than a given threshold; (ii) line of business defining one or more lines of business associated with the processes; (iii) product defining one or more products associated with the processes; (iv) application defining one or more applications associated with the processes; (v) service defining one or more services associated with the processes; etc. Once selections are received on the filter control 310, the processes 302, 304 shown on the matrix are filtered accordingly. In this manner, the user can select a specific set of processes for viewing. Many other configurations are possible.

In optional embodiments, the server device 112 can provide other functionality. For instance, when a new process is added to the database 114, the server device 112 can be programmed to compare the new process to existing processes in the database 114. If the similarity of the new process is sufficient to meet a threshold (e.g., having a similarity score of very high), then the server device 112 can generate a notification to the user. This can allow the user to decide whether to proceed with the new process or utilize an existing process to thereby avoid further redundancy.

As illustrated in the embodiment of FIG. 4, the example server device 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for identifying similar processes, comprising:
one or more processors; and
non-transitory computer-readable storage media encoding instructions which, when executed by the one or more processors, causes the computer system to create:
a similarity engine programmed to use machine learning to analyze a plurality of processes for an enterprise;
a models engine programmed to identify similarities between the plurality of processes using the machine learning; and
a display engine programmed to display the similarities between the plurality of processes.

2. The computer system of claim 1, wherein the similarity engine is further programmed to compare metadata associated with the plurality of processes, with the metadata including: (i) a process name providing a name for each of the plurality of processes; and (ii) a process summary providing a summary of a function for each of the plurality of processes.

3. The computer system of claim 2, wherein the metadata further includes: (iii) a process scope providing a scope for each of the plurality of processes; (iv) a process purpose providing a purpose for each of the plurality of processes; (v) a controls description providing a summary of controls associated with each of the plurality of processes; and (vi) a risk description providing a summary of risks associated with each of the plurality of processes.

4. The computer system of claim 1, wherein the models engine is selected from a group consisting of Doc2Vec, Bidirectional Encoder Representations from Transformers, and Text-to-Text Transfer Transformer.

5. The computer system of claim 1, wherein the models engine is further programmed to estimate a similarity score for pairs of the plurality of processes.

6. The computer system of claim 5, wherein the display engine is further programmed to show the pairs of the plurality of processes having the similarity score meeting a threshold.

7. The computer system of claim 1, comprising further instructions which, when executed by the one or more processors, causes the computer system to create a taxonomy engine programmed to compare taxonomies between the plurality of processes.

8. The computer system of claim 1, comprising further instructions which, when executed by the one or more processors, causes the computer system to create a roles engine programmed to compare roles between the plurality of processes.

9. The computer system of claim 1, wherein the display engine is further programmed to display the plurality of processes on a matrix, wherein the matrix visually shows clusters of processes that are similar.

10. The computer system of claim 9, wherein the display engine is further programmed filter the matrix based upon inputs from a user, wherein the inputs include: (i) a level of similarity defining a specific amount of similarity between the plurality of processes; (ii) a line of business defining one or more lines of business associated with the plurality of processes; (iii) a product defining one or more products associated with the plurality of processes.

11. A method for identifying similar processes, the method comprising:
using machine learning to analyze a plurality of processes for an enterprise;
identifying similarities between the plurality of processes using the machine learning; and
displaying the similarities between the plurality of processes.

12. The method of claim 11, further comprising comparing metadata associated with the plurality of processes, with the metadata including: (i) a process name providing a name for each of the plurality of processes; and (ii) a process summary providing a summary of a function for each of the plurality of processes.

13. The method of claim 12, wherein the metadata further includes: (iii) a process scope providing a scope for each of the plurality of processes; (iv) a process purpose providing a purpose for each of the plurality of processes; (v) a controls description providing a summary of controls associated with each of the plurality of processes; and (vi) a risk description providing a summary of risks associated with each of the plurality of processes.

14. The method of claim 11, wherein the machine learning is selected from a group consisting of Doc2Vec, Bidirectional Encoder Representations from Transformers, and Text-to-Text Transfer Transformer.

15. The method of claim 11, further comprising estimating a similarity score for pairs of the plurality of processes.

16. The method of claim 15, further comprising showing the pairs of the plurality of processes having the similarity score meeting a threshold.

17. The method of claim 11, further comprising comparing taxonomies between the plurality of processes.

18. The method of claim 11, further comprising comparing roles between the plurality of processes.

19. The method of claim 11, further comprising displaying the plurality of processes on a matrix, wherein the matrix visually shows clusters of processes that are similar.

20. The method of claim 19, further comprising filtering the matrix based upon inputs from a user, wherein the inputs include: (i) a level of similarity defining a specific amount of similarity between the plurality of processes; (ii) a line of business defining one or more lines of business associated with the plurality of processes; (iii) a product defining one or more products associated with the plurality of processes.
